(19) United States
(12) Patent Application Publication
(10) Pub. No.: US 2006/0224962 A1
(43) Pub. Date: Oct. 5, 2006

(54) Context menu navigational method for accessing contextual and product-wide choices via remote control

(75) Inventors: Bojana Ostojic, Kirkland, WA (US); Christopher Glein, Seattle, WA (US); Kort Sands, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/095,746

(22) Filed: Mar. 30, 2005

(51) Int. Cl. G06F 9/00

(52) U.S. Cl. 715/716; 715/825; 715/822; 715/841; 715/854

(57) ABSTRACT

An exemplary method includes selecting a media content item displayed on a graphical user interface, issuing a command via a remote control and, in response to the command, displaying a context menu on the graphical user interface wherein the context menu comprises one or more options for actions related to the selected media content item and one or more options for actions unrelated to the selected media content item. Varioius other exemplary methods,devices,systems, etc., are also disclosed.

### RELATED APPLICATIONS

This application is related to U.S. Patent Application entitled, “Enabling UI template customization and reuse through parameterization”, to Glein, Hogle, Stall, Mandryk and Finocchio, filed on Mar. 30, 2005, having Attorney Docket No. MS1-2488US (which is incorporated by reference herein); U.S. Patent Application entitled “System and method for dynamic creation and management of lists on a distance user interface”, to Ostojic, filed on Mar. 30, 2005, having Attorney Docket No. MS1-2489US (which is incorporated by reference herein); and U.S. Patent Application entitled “System for efficient remote projection of rich interactive user interfaces”, to Hogle, filed on March 30, 2005, having Attorney Docket No. MS1-2491US (which is incorporated by reference herein).

### TECHNICAL FIELD

Subject matter disclosed herein relates generally to context menus.

### BACKGROUND

Recent technological innovations are turning the home computer into a multimedia center. For example, the WINDOWS™ XP™ MEDIA CENTER EDITION 2005® operating system (Microsoft Corporation, Redmond, Washington) is an operating system that enables users to enjoy entertainment, personal productivity, and creativity on a personal computer in an easy, complete, and connected way. This operating system includes features that allow a user to store, share, and enjoy photos, music, video, and recorded TV via a personal computer. In essence, such features create a so-called media center personal computer (PC). Media center PCs represent the evolution of PCs into digital media hubs that bring together entertainment choices. A media center PC with the WINDOWS® XP® MEDIA CENTER EDITION 2005™ operating system can even be accessed or controlled using a single remote control.

With respect to use of a remote control for input, the user experience differs in many ways when compared to the user experience associated with input via a keyboard and a mouse. Thus, a user interface and associated input methods typically associated with a 2′ context may not provide the user with a good experience when implemented in a “10′ context”, i.e., where input is via a remote control. Indeed, use of a UI and associated methods developed for a 2′ context, when used in a 10′ context, may deter use.

In general, a user's visual experience in the 10′ context is in many ways more critical than in the 2′ context. The 2′ context is more akin to reading a book (i.e., “normal” text and image presentation) and being able to point at the text or images with your finger while the 10′ context is more akin to watching TV, where a remote control is aimed at a device, where viewing habits for users are quite varied and where viewers are more accustomed to viewing images, single words or short phrases, as opposed to lines of text. Without a doubt, the advent of the 10′ context has raised new issues in the development of user interfaces.

As described herein, various exemplary methods, devices, systems, etc., aim to improve a user's experience outside of the 2′ context or in instances where a user must navigate a plurality of graphical user interfaces.

### SUMMARY

The techniques and mechanisms described herein are directed to context menus. An exemplary computer-implementable method includes selecting a media content item displayed on a graphical user interface, issuing a command via a remote control and, in response to the command, displaying a context menu on the graphical user interface wherein the context menu comprises one or more options for actions related to the selected media content item and one or more options for actions unrelated to the selected media content item. Various other exemplary methods, devices, systems, etc., are also disclosed.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a diagram of an exemplary context that includes a display to display a user interface and a remote control for input and interaction with the user interface.

FIG. 2 is a diagram of exemplary remote control for use in the system of FIG. 1.

FIG. 3 is a diagram of an exemplary user interface that displays a menu of some options related to media content.

FIG. 4 is a diagram of an exemplary user interface that displays a menu of options related to music and that displays music content items (e.g., album covers).

FIG. 5 is a diagram of an exemplary user interface that displays a menu of options related to music and that displays a list of tracks for a music album.

FIG. 6 is a diagram of an exemplary user interface that displays a menu of options related to music and that displays information about a track of a music album.

FIG. 7 is a diagram of an exemplary user interface that displays a menu of options related to music and, in particular, to a music album and that displays information about a track of a music album.

FIG. 8 is a diagram illustrating a context menu as typically found in the 2′ context.

FIG. 9 is a diagram illustrating various exemplary context menus that are optionally suitable for use in the context described with respect to FIG. 1.

FIG. 10 is a diagram of an exemplary user interface that includes an exemplary context menu, a block diagram of an exemplary method and an exemplary context menu hierarchy.

FIG. 11 is a diagram illustrating an exemplary computing environment, which may be used to implement various exemplary methods, etc., described herein.

### DETAILED DESCRIPTION

In the description that follows, various exemplary methods, devices, systems, etc., are presented. These examples rely on various exemplary application or interfaces that include exemplary methods, properties, etc. to facilitate user list creation or list management. As described in the Background Section, issues exist in the 10′ context when compared to the 2′ context and, exemplary technology presented herein is particularly useful for user interfaces for the 10′ context; however, such exemplary technology may be used for other contexts. In particular, such exemplary technology may be used where a user navigates by pages and options presented via one or more context menu enhance the user's experience.

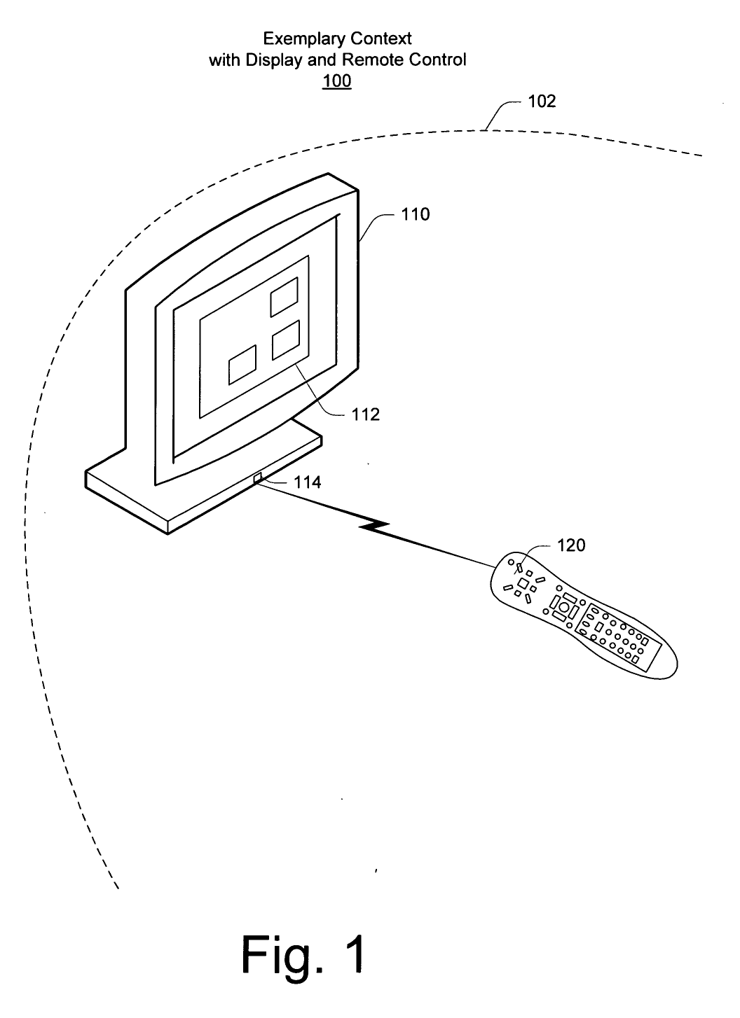

FIG. 1 shows an exemplary context 100 that has a context boundary 102 (e.g., 10′ or other distance). The context boundary 102 is typically defined by a distance or distances between a user and a user interface (UI). The exemplary context 100 is akin to a distance typically found in viewing TV. In the exemplary context 100, a display 110 displays a UI 112 and a remote control 120 communicates with a controller for the display via a communication port 114 (e.g., a remote sensor), which is typically a wireless communication port (e.g., infrared, etc.). The port 114 may be unidirectional from the remote control 120 to the port 114 or bidirectional between the port 114 and the remote control 120. The port 114 could be a peripheral device, or could also be built into either a computer or a monitor (as shown). The controller or host for the display 110 may be a computer located proximate to the display 110 or located remote from the display 110. An exemplary method may receive a command via a sensor for receiving signals from remote control. Such a method may receive the command directly from the sensor or via an intermediary. For example, reception of a command may occur at a host device via a remote device in communication with such a sensor. Various communication techniques exist to allow a computer to provide display information to create a UI.

A user interface that works well at a distance of about ten feet should account for the fact that a typical remote control (e.g., the remote control 120) is smaller and easier to use than a conventional keyboard and mouse; however, it generally provides a more limited form of user input (e.g., due to fewer keys or buttons). And while a greater viewing distance provides a more comfortable experience, it can necessitate features that provide a visual design style to ensure clarity, coherence, and readability.

In both the 2′ context and the 10′ context, the user's expectations, mobility, habits, etc., should be considered when constructing a user interface (e.g., the UI 112). With respect to expectations, the 10′ experience is more like watching television than using a computer. As a result, users expect a dynamic, animated experience. They expect that the input device will make their experience simpler, not more complicated. They may also expect applications to be more convenient, simpler to learn, and easier to use than applications controlled by the keyboard or mouse.

A particular approach to the 10′ context uses a plurality of pages or graphical user interfaces that a user navigates. Each page may include a certain set of options, typically presented as a list of items in a menu. As the user selects options from the menu, events may occur or another user interface may be displayed. As such, a hierarchy exists as to the various pages. In general, a user navigates by jumping from one page to another (e.g., “back”, “forward”, “next”, etc.) or by selecting an item listed on a page's main menu. Thus, a user is typically required to leave one page when a desired functionality is not available on that page. Under such conditions, a user with experience will typically navigate more quickly than one that has not encountered the organization or interconnectedness of pages or functions.

As described herein, various exemplary methods, devices, systems, etc., provide one or more context menus to enhance use of systems that rely on a plurality of pages or graphical user interfaces. Such exemplary technology is particularly useful when implemented in the 10′ context.

General User Interface Guidelines

In the 10′ context, the display may be a TV display, a computer monitor display or a projection screen display. With the advent of HDTVs, LCDs, plasma monitors, interoperability (TV or computer monitor) is often available in a single display.

General guidelines include text and graphics that are sufficiently large for display using lower clarity and resolution associated with a conventional TV display; caution when relying on fixed widths; size and position graphics relative to the screen resolution; avoid use of fine details that may blur on a conventional TV display; where limitations of interlaced scanning are present, size all lines, borders, and text to at least two pixels wide; and be aware that bright colors tend to over-saturate on a conventional TV display.

With respect to text, it is recommended to size all text, especially for critical content such as buttons and links, to at least 20 points. In addition, it is recommended to use lists of short phrases rather than paragraphs; move larger blocks of text onto secondary pages; edit text to remove any nonessential information; to use adequate contrast between text and its background, and to use light and dark values to create contrast.

With respect to a look and feel for UI buttons, an exemplary scheme may use a basic look for buttons associated a particular application (e.g., a basic look for links, option buttons, check boxes, sorting controls, controls to set the view, etc.). Where more than one application requires UI display, each application may have its own look. Such a scheme provides a user with a consistent experience and can help enable the user to quickly identify which items on the page are functional or used for navigation.

It is recommended that buttons be clearly visible against their surroundings and that the functions that they perform be inherent or obvious. For example, a label on a button may describe its function. For example, users can be expected to understand the function of “Save Settings” or “Play DVD” more easily than “OK” or “Go”.

It is recommended that when a user focuses on a button, the button be highlighted in a visually distinct manner, making it more visible than buttons that do not have the focus. A highlighting effect can be achieved by changing the background color of the button, or by placing a brightly colored border around the button.

For consistency and ease of use, a single consistent style of highlighting is recommended for each application (e.g., a highlight color that complements the colors of a particular design). Highlighting is part of a dynamic user experience; users generally notice highlights not just because of their contrast with other elements, but because of the movement of the highlight as they navigate around the page.

In the 10′ context, navigation should refer to not only movement between pages or screens, but also movement between selectable elements within a page. With respect to a remote control, users generally navigate by using the arrow buttons on the remote control to move the input focus to a particular item and then press “enter” to act on the focused item. For most Uls, it is typically recommended that the focus is always on one of the items in the UI.

In the 10′ context, it is recommended that page layouts be simple and clean, with a coherent visual hierarchy. A consistent design, from page to page, may include aligning UI items to a grid. It is further recommended that readability take precedence over decoration and that the inclusion of too many extraneous visual elements be avoided.

As already mentioned, in the 10′ context, a plurality of pages, screen or graphical user interfaces are often used. Further, each page often includes a menu or items with specific functionality. Thus, if a user desires different functionality, then the user typically has to navigate to a different page. Again, in such a system, a user gains experience via repeatedly navigating the plurality of pages and, hence, an experienced user typically has a better impression of the system and can more readily access functions, media, etc. Various exemplary methods, devices, systems, etc., described herein can facilitate access to features and enhance a user's experience through use of one or more context menus. Further, such exemplary technologies can allow even a novice user ready access to a system's functionalities.

Example of a Remote Control

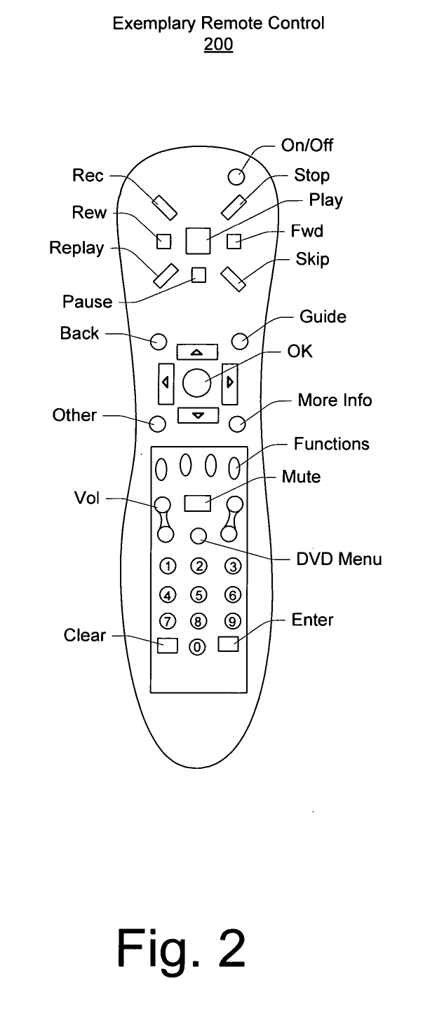

The appearance of a remote control may vary from manufacturer to manufacturer; however, core functionality is typically constant. FIG. 2 shows an exemplary remote control 200 and various buttons and associated functions some of which are described below.

As already mentioned, the remote control interacts with a sensor. A typical sensor may include the following hardware: a receiver component that processes input from the remote control; a circuit for learning commands (e.g., infrared communication commands); a universal serial bus (USB) connection that sends input notifications to software running on a host computer; and two emitter ports. In addition, the sensor normally requires a device driver that may support the Plug and Play specification. A USB cable or other cable may enable users to place a sensor near a monitor so they can point the remote substantially at the monitor when sending commands to the host computer. Alternatively, the sensor might be mounted in the front panel of the computer by the manufacturer, mounted in or on a monitor, etc.

Input from a remote control is typically processed as follows: the sensor receives the signal and forwards it to a device driver on the host computer; the device driver converts the input into a message (e.g., WM_INPUT, WM_APPCOMMAND, WM_KEYDOWN, WM_KEYPRESS, or WM_KEYUP message); the host computer software places these messages in a message queue to be processed; and the foreground application processes messages of interest. For example, a digital media streaming application could process the messages corresponding to the transport buttons (Pause, Play, Stop, Fast Forward, and Rewind) but optionally ignore messages from the numeric keypad.

While remote control design may vary by manufacturer, most remote controls have a set of standard buttons that fall into four categories: navigation buttons (e.g., eHome, Up, Down, Left, Right, OK, Back, Details, Guide, TV/Jump), transport buttons (e.g., Play, Pause, Stop, Record, Fast Forward, Rewind, Skip, Replay, AV), power control buttons (e.g., Volume+, Volume−, Chan/Page+, Chan/Page−, Mute, DVD Menu, Standby) and data entry buttons (e.g., 0, 1, 2 ABC, 3 DEF, 4 GHI, 5 JKL, 6 MNO, 7 PQRS, 8 TUV, 9 WXYZ, Clear, Enter).

In addition to required buttons, a manufacturer may incorporate optional buttons. Optional buttons may include shortcut buttons (e.g., My TV, My Music, Recorded TV, My Pictures, My Videos), DVD buttons (e.g., DVD Angle, DVD Audio, DVD Subtitle), keypad buttons (e.g., #, *), and OEM-specific buttons (e.g., OEM 1, OEM 2). Various applications may not rely on the presence of these “optional” buttons.

An exemplary remote control typically includes various keyboard equivalents. For example, Table 1 shows a remote control button, an associated command and a keyboard equivalent. Note that the keyboard equivalent, in some instances, requires multiple keys (e.g., the keyboard equivalent for “Fwd” on the remote control requires three keys “CTRL+SHIFT+F”). Further, due to the nature of media consumption in the 10 ′ context, some remote control buttons may not have standard keyboard equivalents (e.g., “Rewind”).

TABLE 1
Remote Control and Keyboard Equivalents

| | | Keyboard |
|---|---|---|
| Button | Command | equivalent |
| Back | APPCOMMAND_BROWSER_BACK | BACKSPACE |
| Chan/Page | APPCOMMAND_MEDIA_CHANNEL_DOWN | MINUS SIGN (−) |
| Down | | CTRL + MINUS |
| | | SIGN |
| | | PAGE DOWN |
| Chan/Page | APPCOMMAND_MEDIA_CHANNEL_UP | PLUS SIGN (+) |
| Up | | CTRL + SHIFT + PLUS |
| | | SIGN |
| | | PAGE UP |
| Clear | VK_ESCAPE | ESC |
| Down | VK_DOWN | DOWN ARROW |
| Enter | — | ENTER |
| Fwd | APPCOMMAND_MEDIA_FASTFORWARD | CTRL + SHIFT + F |
| Left | VK_LEFT | LEFT ARROW |
| Mute | APPCOMMAND_VOLUME_MUTE | F8 |
| Number keys | VK_0 to VK_9 | 0 to 9 |
| OK | VK_RETURN | ENTER |
| | | SPACEBAR |
| Pause | APPCOMMAND_MEDIA_PAUSE | CTRL + P |
| Play | APPCOMMAND_MEDIA_PLAY | CTRL + SHIFT + P |
| Record | APPCOMMAND_MEDIA_RECORD | CTRL + R |
| Replay | APPCOMMAND_MEDIA_PREVIOUSTRACK | CTRL + B |
| Rewind | APPCOMMAND_MEDIA_REWIND | — |
| Right | VK_RIGHT | RIGHT ARROW |
| Skip | APPCOMMAND_MEDIA_NEXTTRACK | CTRL + F |
| Stop | APPCOMMAND_MEDIA_STOP | CTRL + S |
| Up | VK_UP | UP ARROW |
| Vol Down | APPCOMMAND_VOLUME_DOWN | F9 |
| Vol Up | APPCOMMAND_VOLUME_UP | F10 |

With respect to “mouse equivalents”, most mice have limited functionality. In general, mice are used for pointing and for selecting. A typically mouse has a left button and a right button, where most users have become accustomed to the standard “left button click” to select and “right button click” for display of a context menu.

As described herein, an exemplary remote control includes one or more buttons or other input mechanism(s) that issue a command or commands for display of one or more exemplary context menus. For example, an exemplary remote control may include a “More Info” button or a “Details” button, that when depressed by a user, issue a command or commands that cause display of a context menu. The relationship of such exemplary context menus to an overall hierarchy of pages or graphical user interfaces is discussed in more detail below. Further, a relationship between media content in “focus” and one or more exemplary context menus is also discussed.

Without such exemplary context menus, a user may experience difficulty or limitations when trying to associate specific navigational choices with content in focus because as the focus moves from the content in focus to a navigational choice, the context of the previously selected content is lost. Various exemplary context menus mitigate this issue by associating the media content in focus with navigational choices displayed in such menus. Various exemplary context menus allow for additional exposure of navigational choices.

Various exemplary context menus allow access to multi-tiered choices of navigational scope for media content via, for example, a remote control. In a system with three-tiers of navigational scope, a first tier may include choices that pertain specifically to an item in focus (e.g., for a music song: play it, view details of it, etc.); a second tier may include choices that pertain to the experience to which the items in focus belong (e.g., for music: bum a CD/DVD, etc); and a third tier may include choices that pertain to global product-wide choices that can be run/experienced concurrently with the items/experience in focus (e.g., while in music: access to Instant Messenger to start a conversation while still in music). In sum, a tiered approach may include a spectrum of choices or functionalities ranging from media content specific to global, where there is no relationship to particular media content in focus. Various exemplary context menus optionally allow third parties to plug-in their application specific choices into such menus to offer additional navigational options.

With respect to tiers, an exemplary context menu may include at least one option from a media content related tier of options, at least one option from a user experience-of-media content related tier of options, and at least one option from a global tier of options wherein the global tier of options typically includes at least one option unrelated to the selected media content item. For example, such a media content related tier of options may include an option to play media content; such a user experience-of-media content related tier of options may include an option to store media content; and such a global tier of options may include an option to invoke a messenger service. Of course, other types of tiers, options, etc., may be used in conjunction with an exemplary context menu.

Examples of User Interfaces and Various Exemplary Technologies

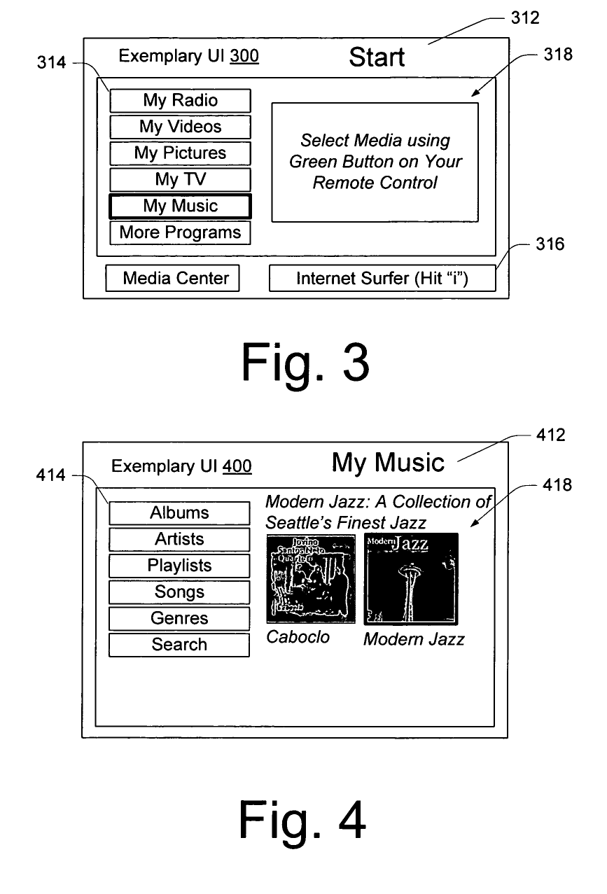

FIG. 3 shows an exemplary user interface 300 that includes a title 312, a menu 314, an information area 316 and a display area 318. The title 312 indicates that the UI 300 is for a starting point and hence includes a start menu 314 for use in navigating various types of media, such as, but not limited to, radio (My Radio), video (My Video), pictures (My Pictures), television (My TV), audio/music (My Music) and other programs (More Programs). The information area 316 displays useful information, in this instance, navigation information for launching an Internet surfer application. In this example, the display area 318 displays information for helping a user navigate the menu 314.

The exemplary user interface 300 is devoid of specific media content, however, upon selection of an item or option in the menu 314, a new user interface will be displayed. FIG. 4 shows an exemplary user interface 400 that corresponds to the “My Music” item of the menu 314 of the user interface 300 as indicated by the title “My Music” 412.

In the aforementioned MEDIA CENTER EDITION® operating system, an option entitled “My Music” offers a user access to, for example, personal or online music collections. A user may copy a music CD into a library, create a playlist on the fly just like a jukebox, save as a playlist, or edit album details such as ratings, etc. Albums may be browsed by album cover or alternately by artist, songs, genres, or searched. Support for audio CD burning, for example, using a third party application, may be accessed. As described with respect to the system of FIG. 1, a user may use such an operating system (or suitable UI framework) to browse, organize, and play music by issuing commands via a remote control.

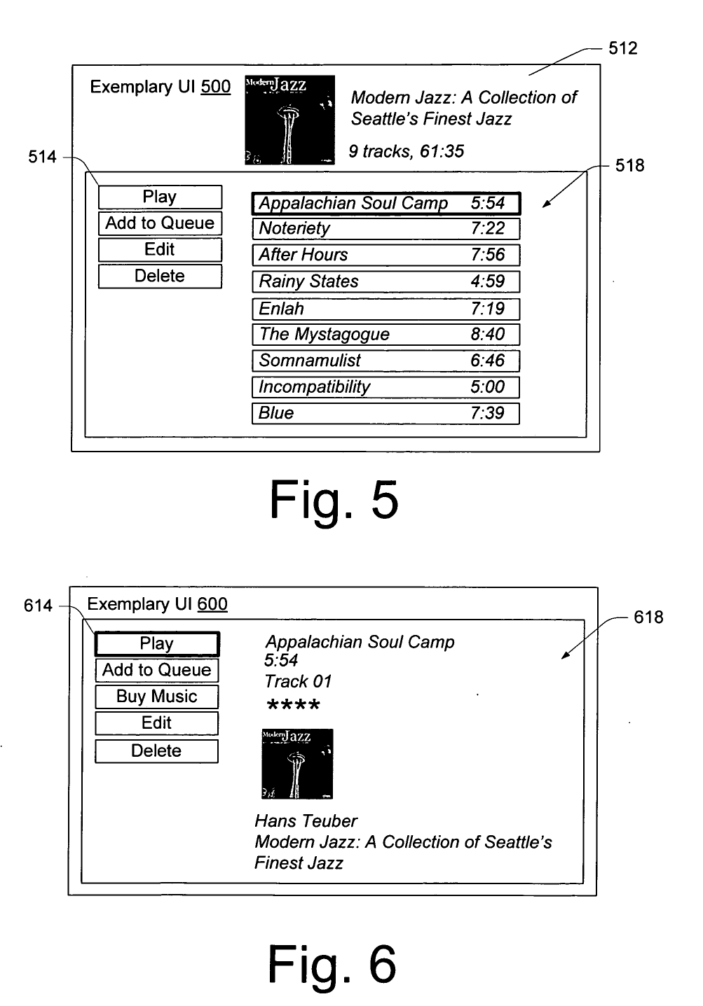

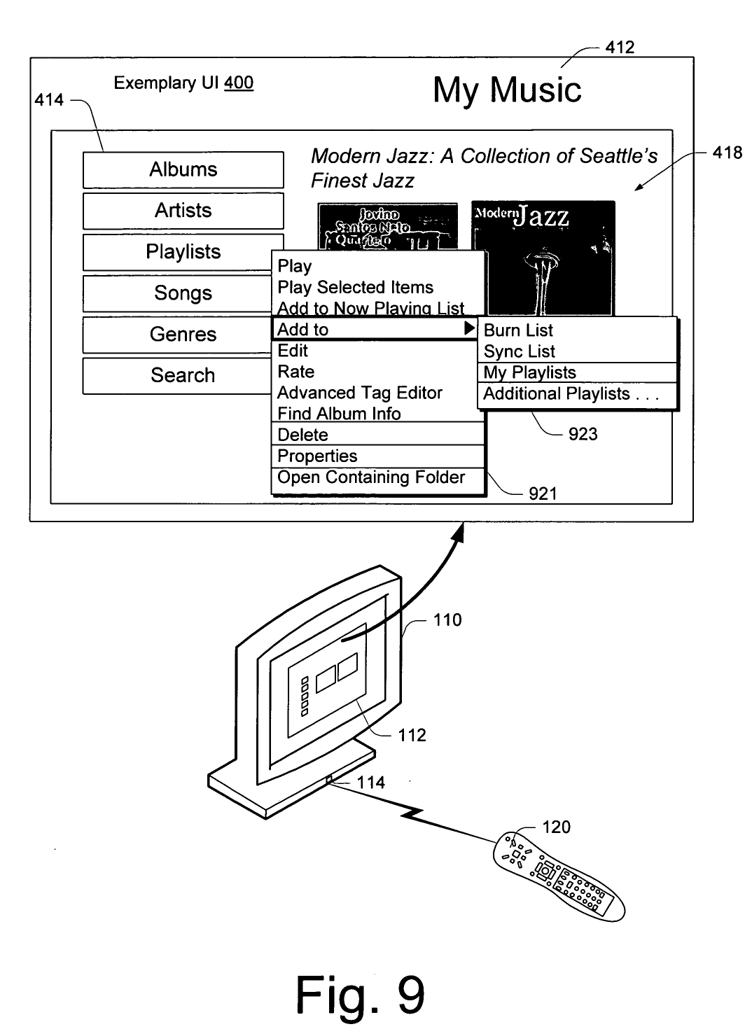

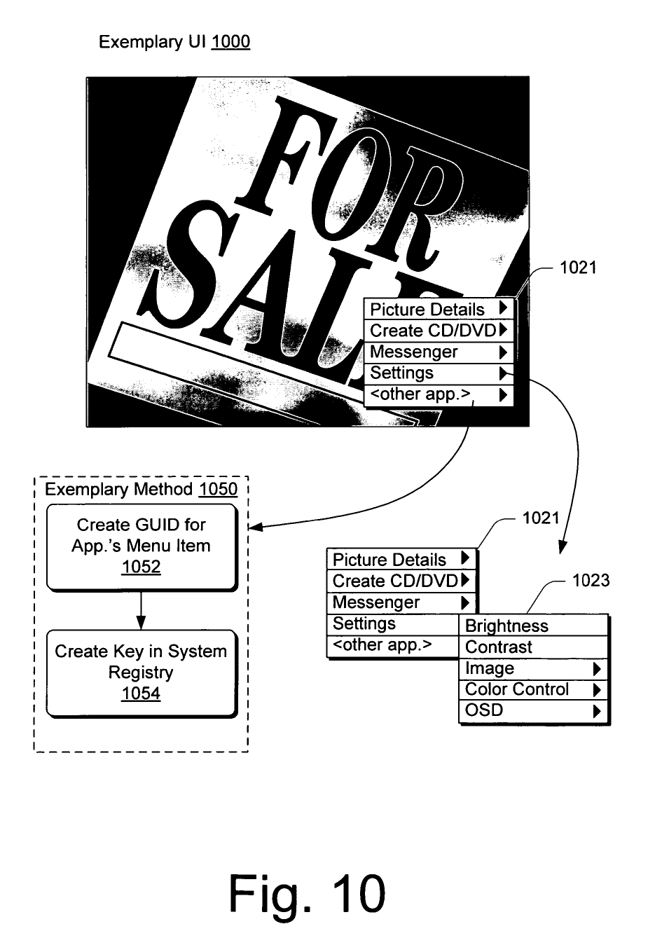

Referring again to the user interface 400, a menu 414 displays various items or options germane to actions for music and organization of or searching for particular music. In this example, a display area 418 displays the user's small, but high quality, library of music CDs or albums, which are considered media content items. Thus, the exemplary user interface 400 displays media content items, i.e., a music CD entitled “Caboclo” and a music CD entitled “Modern Jazz: A Collection of Seattle's Finest Jazz”. According to the exemplary technology presented herein, a user has several options for managing the media content items displayed in the exemplary user interface 400 (and the media content associated with the media content items). One option is demonstrated in FIGS. 5, 6 and 7 while another option is shown with respect to FIG. 9.

In FIG. 4, the user has selected the “Modern Jazz” music CD, upon making this selection, a user interface will be displayed that includes more information about the selected music CD. FIG. 5 shows an exemplary user interface 500 that displays in a title area 512 a small graphic of the cover of the music CD, the title of the music CD, the number of tracks on the music CD and the total playing time of the music CD. A menu 514 displays various options for initiating actions such as “Play”, “Add to Queue”, “Edit” and “Delete”. A display area 518 displays song titles for the 9 tracks and the playing time for each track. A user may select a particular track (e.g., “Appalachian Soul Camp”) and enter play or another suitable command on, for example, a remote control. Alternatively, a user may select “Play” from the menu 514 and cause the entire music CD to be played or selected song(s) to be played.

An exemplary user interface 600 corresponds to a user's selection of the song “Appalachian Soul Camp”. A menu 614 displays various items or options such as “Play”, “Add to Queue”, “Buy Music”, “Edit” and “Delete”. Of course, other items may be displayed as appropriate. A display area 618 displays the song title, the playing time of the track, the track number, a rating of the song, a graphic of the cover of the music CD, name of the artist (“Hans Teuber”) and the title of the music CD. Referring again to the menu 614, items such as “Buy Music” may be helpful when a user accesses a music database, for example, via the Internet. In this particular example, the user has selected the “Play” item on the menu 614.

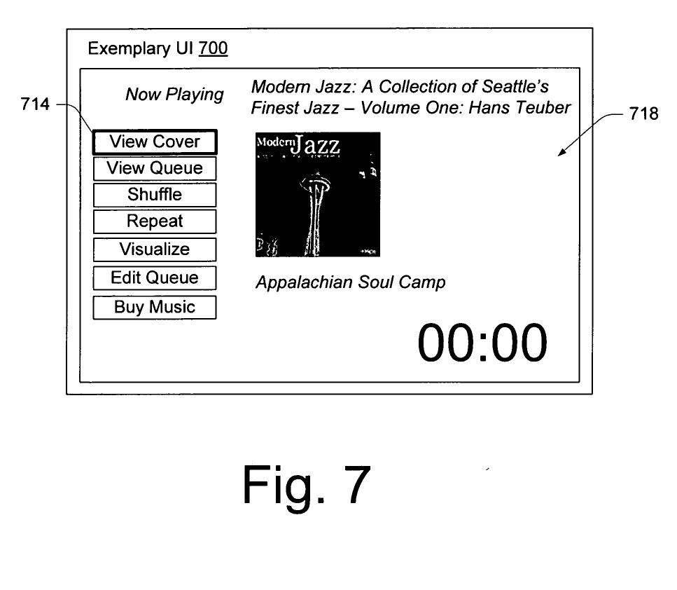

In response to the user's selection of “Play” from the menu 614 of the user interface 600, another user interface is optionally displayed. FIG. 7 shows an exemplary user interface 700 that includes a menu 714 and a display area 718 that displays information pertaining to the song “Appalachian Soul Camp” on the “Modern Jazz” music CD. The menu 714 includes various items or options such as “View Cover”, “View Queue”, “Shuffle”, “Repeat”, “Visualize”, “Edit Queue”, “Buy Music”, etc. Thus, the exemplary user interface 700 may represent a final stop along a user's path to listening to a song on a music CD. As described herein, an alternative path from display of media content items to consumption of content or optionally other actions is also provided.

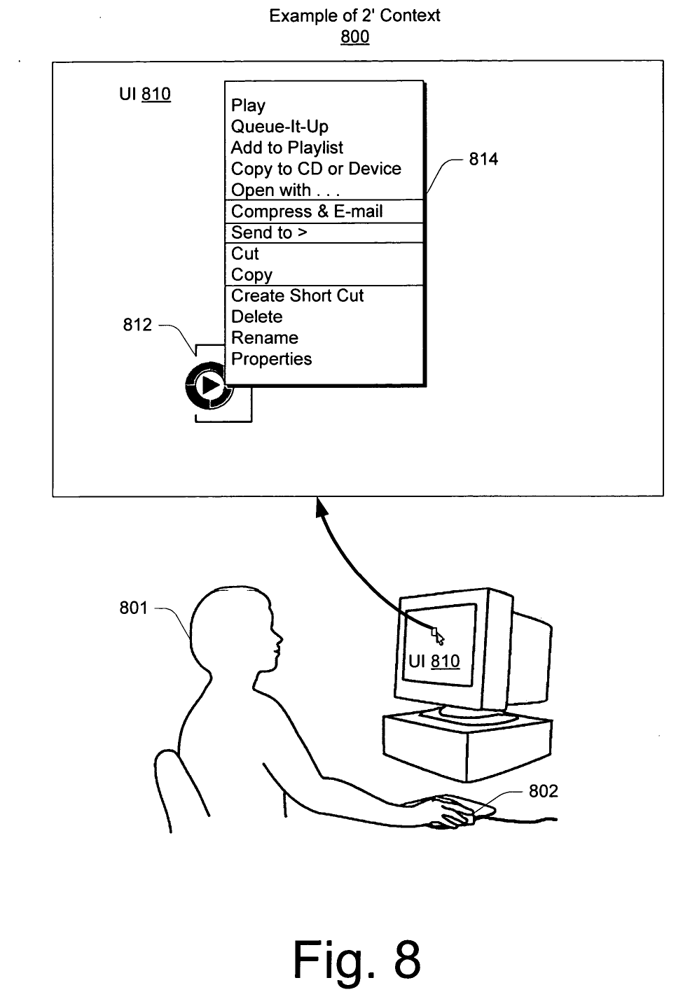

FIG. 8 shows an example of a user operating a user interface in the 2′ context 800. Again, in the 2′ context, a keyboard and a mouse are typically used for input. As shown, a user 801 views a user interface 810 and navigates the user interface 810 using a mouse 802. In this example, the user 810 selects a media file 812 and then depresses a right mouse button to issue a command that causes a context menu 814 to be displayed on the user interface 810. The context menu 814 includes various items or options that pertain to the media file 812. In the 10′ context, as already explained, a user's experience differs significantly from that of the 2′ context. In particular, the user generally does not navigate user interfaces using a mouse but rather using a remote control.

FIG. 9 shows the exemplary user interface 400 of FIG. 4, which includes display of media content items (i.e., a music CD “Caboclo” and a music CD “Modem Jazz”). Also shown in FIG. 9 are a monitor 110, a display area 112, a sensor 114 and a remote control 120. In this example, a user selects media content displayed on the user interface 400 as presented on the monitor 110 using the remote control 120. Then the user has the option of proceeding as previously described with respect to FIGS. 3-7 and another option that includes pressing a button on the remote control 120 to issue a command that causes display of an exemplary context menu 921 on the exemplary user interface 400. Once the context menu 921 is displayed, the user may select any of the various items or options to thereby cause display of additional items, for example, consider the sub-context menu 923 that pertains to the “Add to” item.

The exemplary context menu 921 allows a user to by pass certain user interfaces or procedures by pressing a button on a remote control (e.g., a “More Info” button). While the example of FIG. 9 shows the exemplary user interface 400 of FIG. 4 as a base interface in which the context menu 921 is displayed, such a context menu may be displayed whenever media content (e.g., actual content or one or more media content items) appears in a user interface. For example, the user interfaces 500, 600 and 700 all display at least one media content item. A user may thus focus on any of the displayed media content items in such interfaces, depress a button on a remote control and thereby cause display of one or more exemplary context menus.

Consider the exemplary user interface 500, which displays a list of songs, i.e., audio items that represent audio content. A user may select a song from the list and depress a button on a remote control to thereby cause display of a context menu wherein one or more items in the context menu pertain to actions applicable to the song (e.g., play, add to queue, buy, etc.). The context menu may also include other items that pertain to actions not specifically related to the song (e.g., communication interface, audio settings, visualizations, etc.).

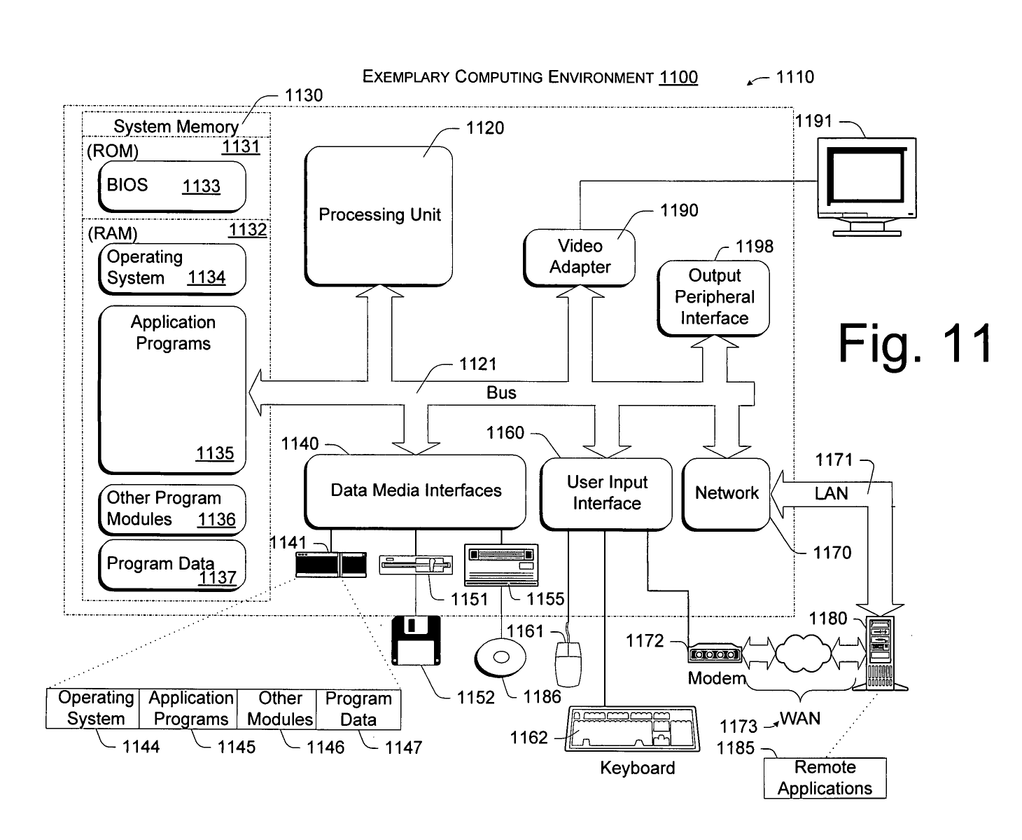

FIG. 10 shows an exemplary user interface 1000 that displays a full-screen image “For Sale”. Upon issuance of a command, an exemplary context menu 1021 appears on the user interface that is visible with respect to the full-screen image “For Sale”. While the exemplary context menu 1021 includes solid fill, a context menu may have a transparent background and text characteristics that are fairly certain to allow a user to view the context menu items with respect to a displayed image (i.e., displayed media content). In instances where displayed media content does not occupy the full-screen, an unoccupied portion of the screen may be used to display the context menu.

The full-screen image “For Sale”, may be a photograph accessible via the “My Pictures” menu item or option of the exemplary user interface 300 of FIG. 3 (i.e., the “Start” screen). The aforementioned MEDIA CENTER EDITION™ operating system includes such a start screen that allows a user to view photo collections by folder and sort by date and folder; import photos from digital cameras or memory cards and view as a slideshow; and add a music soundtrack, zoom effects, etc. In addition, enhanced photo editing technology may be accessed to rotate, crop, fix color on photos, etc. Printing media content may also occur via user command. An exemplary menu may allow a user to share photos online via user input, for example, using a remote control.

The exemplary context menu 1021 includes a picture details item, a create CD/DVD item, a messenger item (e.g., for a messenger service), a settings item and an “other application” item. Any of these items, as appropriate, may allow for display of one or more sub-context menus. Further, the items or options displayed may vary depending on the particular user interfaces being used to display media content (e.g., a full-screen image) or a media content item (e.g., an image of a cover for a music CD). For example, if a user interface displays a menu that includes items such as “Play”, then an exemplary context menu may display items other than “Play”.

With respect to sub-context menus, a scenario appears where the “Settings” item of the context menu 1021 allows for display of a sub-context menu 1023. In this example, the sub-context menu 1023 displays a brightness item, a contrast item, an image item, a color control item and an OSD item. A user may select any of these items, for example, using a remote control. Such an exemplary context menu hierarchy allows a user to retain a particular graphical user interface while being able to determine various options.

While such options are preferably related to media content viewed or a media content item selected, other options may exist such as, but not limited to, the “Messenger” item (e.g., for an instant messaging service, etc.). This item can allow a user to invoke a communication interface. For example, a user may be viewing a sporting event in full-screen mode and desire to contact a friend about a score, a statistic, etc. Without leaving the full-screen mode, the user presses a button on a remote control to cause display of an exemplary context menu that includes a messenger or other communication item. The user selects this option, which invokes a communication interface, and then sends a message to the friend. After sending the message, the communication interface and the context menu close. All of these actions may occur without the user having to exit the full-screen mode for viewing the sporting event. Thus, the user's experience is enhanced with minimal disturbance to viewing media content.

With respect to a messenger service, while generally unrelated to media content, such a messenger service is optionally used to send or share media content. For example, the WINDOWS® messenger for the WINDOWS® XP operating system allows for sharing of pictures or other files. A user may use such a messenger without experiencing file size constraints that may be encountered when transferring a file or files using an email system. A user may use such a messenger service to gain access to a variety of features (e.g., video, talk or text conversation, determining who is online, etc.).

An exemplary method allows a user to view a base graphical user interface that includes a context menu and to select a messenger service option from the context menu to thereby invoke a messenger service that causes display of a foreground graphic while still displaying at least part of the base graphical user interface. In such an exemplary method, the base graphical user interface optionally displays a full-screen image (e.g., picture or video). In another example, the base graphical user interface displays less than a full-screen image (e.g., picture or video) whereby the foreground graphic does not interfere with the image (i.e., displayed in a region not used by the image). Thus, in some examples, a messenger service may cause display of an overlay graphic or may cause display of a graphic in a region not occupied by a media image (e.g., in a manner whereby the graphic does not obscure the media image).

FIG. 10 also shows an exemplary method 1050 for entering information in the context menu, in particular, entering an item in the context menu 1021. The exemplary method 1050 includes a create GUID block that creates a GUID (e.g., a globally unique identifier) for an application's context menu item. The exemplary method 1050 also includes a create key in system registry block 1054 for the application. Together, these two actions allow a user or an application developer to customize an exemplary context menu. An application listed as an item in a context menu may be a third-party application, for example, an application that is not native to the operating system or a user interface/media framework.

As described herein, various technologies allow for display of one or more exemplary context menus. Such technology is advantageous where a user interacts with a device via a remote control, for example, in the aforementioned 10′ context. The 10′ context generally relies on a plurality of graphical user interfaces and commands that allow a user to navigate the plurality of graphical user interfaces. However, at times, navigating away from a particular graphical user interface is undesirable. Various exemplary context menus allow a user to explore options without navigating away from a particular graphical user interface.

An exemplary method includes selecting a media content item displayed on a graphical user interface, issuing a command via a remote control and, in response to the command, displaying an exemplary context menu on the graphical user interface wherein the context menu comprises one or more options for actions related to the selected media content item and one or more options for actions unrelated to the selected media content item. In such an exemplary method, the graphical user interface may be a single graphical user interface of a hierarchy of graphical user interfaces that pertain to audio or visual media. Thus, through use of such an exemplary context menu, a user may initiate actions associated with other graphical user interfaces without navigating away from a current graphical user interface. Such an exemplary context menu can also allow for initiating an action related to a selected media content item while still displaying a particular graphical user interface, i.e., navigation to another graphical user interface is not necessarily required.

An exemplary method includes displaying media content using a graphical user interface, issuing a command via a remote control, in response to the command, displaying an exemplary context menu on the graphical user interface wherein the context menu comprises one or more options for actions related to the displayed media content and one or more options for actions unrelated to the displayed media content and executing an action unrelated to the displayed media content while still displaying the media content on the graphical user interface. Such a graphical user interface may be a single graphical user interface of a hierarchy of graphical user interfaces that pertain to audio or visual media.

An exemplary system includes a sensor to receive signals transmitted through air (e.g., the sensor 114 of FIG. 1), a computer to receive information from the sensor, an operating system for operating the computer, a hierarchy of graphical user interfaces wherein at least some graphical user interfaces allow for selection of visual media content and initiating actions for display of selected visual media content and at least some graphical user interfaces allow for selection of audio media content and initiating actions for play of selected audio media content (e.g., the graphical user interfaces 300, 400, 500, 600, 700 and 1000) and wherein reception of a signal by the sensor causes the computer to call for display of an exemplary context menu on a graphical user interface wherein the context menu comprises options for actions associated with more than one of the graphical user interfaces. While various examples refer to media content context menus, other examples may include “context” menus for non-media content items.

Exemplary Computing Environment

The various examples may be implemented in different computer environments. The computer environment shown in FIG. 11 is only one example of a computer environment and is not intended to suggest any limitation as to the scope of use or functionality of the computer and network architectures suitable for use. Neither should the computer environment be interpreted as having any dependency or requirement relating to any one or combination of components illustrated in the example computer environment.

FIG. 11 illustrates an example of a suitable computing system environment 1100 on which various exemplary methods may be implemented. Various exemplary devices or systems may include any of the features of the exemplary environment 1100. The The computing system environment 1100 is only one example of a suitable computing environment and is not intended to suggest any limitation as to the scope of use or functionality of the invention. Neither should the computing environment 1100 be interpreted as having any dependency or requirement relating to any one or combination of components illustrated in the exemplary operating environment 1100.

Various exemplary methods are operational with numerous other general purpose or special purpose computing system environments or configurations. Examples of well known computing systems, environments, and/or configurations that may be suitable for implementation or use include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like. For example, the exemplary context 100 of FIG. 1 may use a remote computer to generate information for display of a UI wherein the displayed UI operates in conjunction with a remote control or other input device.

Various exemplary methods, applications, etc., may be described in the general context of computer-executable instructions, such as program modules, being executed by a computer. Generally, program modules include routines, programs, objects, components, data structures, etc., that perform particular tasks or implement particular abstract data types. Various exemplary methods may also be practiced in distributed computing environments where tasks are performed by remote processing devices that are linked through a communications network or other communication (e.g., infrared, etc.). In a distributed computing environment, program modules may be located in both local and remote computer storage media including memory storage devices.

With reference to FIG. 11, an exemplary system for implementing the various exemplary methods includes a general purpose computing device in the form of a computer 1110. Components of computer 1110 may include, but are not limited to, a processing unit 1120, a system memory 1130, and a system bus 1121 that couples various system components including the system memory 1130 to the processing unit 1120. The system bus 1121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1110 typically includes a variety of computer readable media. Computer readable media can be any available media that can be accessed by computer 1110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1130 includes computer storage media in the form of volatile and/or nonvolatile memory such as read only memory (ROM) 1131 and random access memory (RAM) 1132. A basic input/output system 1133 (BIOS), containing the basic routines that help to transfer information between elements within computer 810, such as during start-up, is typically stored in ROM 1131. RAM 1132 typically contains data and/or program modules that are immediately accessible to and/or presently being operated on by processing unit 1120. By way of example, and not limitation, FIG. 11 illustrates operating system 1134, application programs 1135, other program modules 1136, and program data 1137.

The computer 1110 may also include other removable/non-removable, volatile/nonvolatile computer storage media. By way of example only, FIG. 11 illustrates a hard disk drive 1141 that reads from or writes to non-removable, nonvolatile magnetic media, a magnetic disk drive 1151 that reads from or writes to a removable, nonvolatile magnetic disk 1152, and an optical disk drive 1155 that reads from or writes to a removable, nonvolatile optical disk 1156 such as a CD ROM or other optical media (e.g., DVD, etc.). Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1141 is typically connected to the system bus 1121 through a data media interface such as interface 1140, and magnetic disk drive 1151 and optical disk drive 1155 are typically connected to the system bus 1121 a data media interface that is optionally a removable memory interface. For purposes of explanation of the particular example, the magnetic disk drive 1151 and the optical disk drive use the data media interface 1140.

The drives and their associated computer storage media discussed above and illustrated in FIG. 11, provide storage of computer readable instructions, data structures, program modules and other data for the computer 1110. In FIG. 11, for example, hard disk drive 1141 is illustrated as storing operating system 1144, application programs 1145, other program modules 1146, and program data 1147. Note that these components can either be the same as or different from operating system 534, application programs 1135, other program modules 1136, and program data 1137. Operating system 1144, application programs 1145, other program modules 1146, and program data 1147 are given different numbers here to illustrate that, at a minimum, they are different copies. A user may enter commands and information into the computer 1110 through input devices such as a keyboard 1162 and pointing device 1161, commonly referred to as a mouse, trackball or touch pad. Other input devices (not shown) may include a microphone, joystick, game pad, satellite dish, scanner, or the like. These and other input devices are often connected to the processing unit 1120 through a user input interface 1160 that is coupled to the system bus 1121, but may be connected by other interface and bus structures, such as a parallel port, game port or a universal serial bus (USB). A monitor 1191 or other type of display device is also connected to the system bus 1121 via an interface, such as a video interface 1190. In addition to the monitor 1191, computers may also include other peripheral output devices such as speakers and printer, which may be connected through a output peripheral interface 1195.

The computer 1110 may operate in a networked environment using logical connections to one or more remote computers, such as a remote computer 1180. The remote computer 1180 may be a personal computer, a server, a router, a network PC, a peer device or other common network node, and typically includes many or all of the features described above relative to the computer 1110. The logical connections depicted in FIG. 8 include a local area network (LAN) 1171 and a wide area network (WAN) 1173, but may also include other networks. Such networking environments are commonplace in offices, enterprise-wide computer networks, intranets and the Internet.

When used in a LAN networking environment, the computer 1110 is connected to the LAN 1171 through a network interface or adapter 1170. When used in a WAN networking environment, the computer 1110 typically includes a modem 1172 or other means for establishing communications over the WAN 1173, such as the Internet. The modem 1172, which may be internal or external, may be connected to the system bus 1121 via the user input interface 1160, or other appropriate mechanism. In a networked environment, program modules depicted relative to the computer 1110, or portions thereof, may be stored in a remote memory storage device. By way of example, and not limitation, FIG. 11 illustrates remote application programs 1185 as residing on the remote computer 1180 (e.g., in memory of the remote computer 1180). It will be appreciated that the network connections shown are exemplary and other means of establishing a communications link between the computers may be used.

Although various exemplary methods, devices, systems, etc., have been described in language specific to structural features and/or methodological acts, it is to be understood that the subject matter defined in the appended claims is not necessarily limited to the specific features or acts described. Rather, the specific features and acts are disclosed as exemplary forms of implementing the claimed subject matter.

1. A computer-implemented method comprising:
selecting a media content item displayed on a graphical user interface;
receiving a command issued via a remote control; and
in response to the command, displaying a context menu on the graphical user interface wherein the context menu comprises one or more options for actions related to the selected media content item and one or more options for actions unrelated to the selected media content item.

2. The computer-implemented method of claim 1, wherein the graphical user interface comprises a single graphical user interface of a hierarchy of graphical user interfaces.

3. The computer-implemented method of claim 2 wherein the one or more options for actions related to the selected media content item correspond to options for actions associated with graphical user interfaces of the hierarchy of graphical user interfaces.

4. The computer-implemented method of claim 1 wherein the context menu allows for initiating an action related to the selected media content item while displaying the graphical user interface.

5. The computer-implemented method of claim 1 wherein the one or more options unrelated to the selected media content item comprises an option for a messenger service.

6. The computer-implemented method of claim 5 wherein selection of the messenger service option invokes a messenger service that causes display of an overlay graphic that overlays a media image.

7. The computer-implemented method of claim 5 wherein the graphical user interface displays a media image and selection of the messenger service option invokes a messenger service that causes display of a graphic that does not obscure the media image.

8. The computer-implemented method of claim 1 wherein the graphical user interface comprises a single graphical user interface of a hierarchy of graphical user interfaces associated with an operating system.

9. The computer-implemented method of claim 8 wherein the context menu comprises an option for invoking an application that is not native to the operating system.

10. The computer-implemented method of claim 1 wherein the receiving occurs via a sensor for receiving signals from the remote control.

11. The computer-implemented method of claim 10 wherein the receiving occurs at a host device via a remote device in communication with the sensor.

12. The computer-implemented method of claim 1 wherein the context menu comprises at least one option from a media content related tier of options, at least one option from a user experience-of-media content related tier of options, and at least one option from a global tier of options wherein the global tier of options comprises at least one option unrelated to the selected media content item.

13. The computer-implemented method of claim 12 wherein the media content related tier of options comprises an option to play media content.

14. The computer-implemented method of claim 12 wherein the user experience-of-media content related tier of options comprises an option to store media content.

15. The computer-implemented method of claim 12 wherein the global tier of options comprises an option to invoke a messenger service.

16. A computer-readable medium having computer-executable instructions for performing the method recited in claim 1.

17. A computer-implemented method comprising:
displaying media content using a graphical user interface;
receiving a command issued via a remote control;
in response to the command, displaying a context menu on the graphical user interface wherein the context menu comprises one or more options for actions related to the displayed media content and one or more options for actions unrelated to the displayed media content; and
executing an action unrelated to the displayed media content while still displaying the media content on the graphical user interface.

18. The computer-implemented method of claim 17, wherein the graphical user interface comprises a single graphical user interface of a hierarchy of graphical user interfaces that pertain to audio and visual media.

19. The computer-implemented method of claim 18 wherein the one or more options for actions related to the displayed media content correspond to options for actions associated with graphical user interfaces of the hierarchy of graphical user interfaces.

20. A system for multimedia comprising:
a sensor to receive signals transmitted through air;
a computer to receive information from the sensor;
an operating system for operating the computer;
a hierarchy of grahical user interfaces wherein at least some graphical user interfaces allow for selection of visual media content and initiating actions for display of selected visual media content and at least some graphical user interfaces allow for selection of audio content and initiating actions for play of selected audio media content; and
wherein reception of a signal by the sensor causes the computer to call for display of a context menu on a graphical user interface wherein the context menu comprises options for actions associated with more than one of the graphical user interfaces.
